(19) United States
(12) Patent Application Publication
(10) Pub. No.: US 2004/0054452 A1
(43) Pub. Date: Mar. 18, 2004

(54) Methods and means for monitoring driver alertness and display means for displaying information related thereto

(76) Inventor: Mats Bjorkman, Kode (SE)

Correspondence Address: YOUNG & THOMPSON, 745 SOUTH 23RD STREET 2ND FLOOR, ARLINGTON, VA, 22202

(21) Appl. No.: 10/343,608

(22) PCT Filed: Aug. 1, 2001
(86) PCT No.: PCT/SE01/01697

(30) Foreign Application Priority Data
Aug. 1, 2000 (SE) 0002804-3

(51) Int. Cl. G06F 19/00

(52) U.S. Cl. 701/29; 701/1; 701/33

(57) ABSTRACT

The present invention relates to a method and a device of measuring the interaction between a driver and a vehicle in use to decide the security coefficient for vehicles and/or for drivers, and an instrument showing said safety coefficients. The invention is characterised in that a measuring/registering and maybe calculating parasite system (16) is connected to the steering system (12) of the vehicle for a registering measurement of the signal activity (19) between driver (14) and vehicle (18), that implementing a known measuring impulse in the steering system in the ordinary noise during the manoeuvring of the vehicle, whereby the response from the driver on said measuring impulse will be registered by the parasite system (16) which also compare the difference between an induced impulse and the response pulse from the driver and presents said difference on a graphic display unit, as a characteristic sound, or store it in a memory device.

The present invention relates to a method to measure and a device to react upon and register the interaction between a driver and a vehicle, more precisely to a method and a device to decide dangerous deviations and discrepancies in the behaviour of the driver and/or in the dynamic behaviour of a vehicle, the deviations and discrepancies of which can be seen in a disturbed interaction between the driver and the vehicle. A safety critical behaviour of a vehicle can be valid both to the manoeuvres of the “norm or standard driver” as well of these for the present driver. In the first case norm or standard data for the dynamic characteristics of the vehicle or its behaviour profile is obtained. Furthermore the invention relates to an instrument or a graphic display unit where the result of the measurements and the result of an algorithmic calculation for said measurements is presented.

Factors influencing the quality or purity of the interaction is e.g. degree of intoxication, use of drugs, fatigue, talking in the mobile phone, fear of slippery roads, poor visibility, etc.

The combination driver/vehicle can be seen as a dynamic control system where the driver all the time tries to keep control and a good safety margin in the present driving situation. Through the senses the driver will have a continues feed back about the situation from the vehicle and from other road users and the environment, and each deviation from the expected condition will mostly be corrected automatically by the driver by different corrections of the vehicle to have it change its direction and/or speed, etc. Thus it is a question of a neurologic motor and sensor signal transmission and in the neurologic field expressions as degree of connection, reaction time and delay in the co-operation between motor and sensor actions are used.

In our earlier patent application PCT/SE01/00334 the principle to give an impulse to a vehicle is stated and which impulse the driver spontaneously or subliminally reacts upon with the purpose to be able to map the degree of attention of the driver in the activity of driving a vehicle. The present invention relates to some important developments of said invention.

Thus the main object of the present invention is to obtain a method to check and a system to check to register values of important parameters in the activity of driving a vehicle, which parameters up till now only exist in the subconscious, and from these values determine the existing safety margin or value of purity of the driver and/or of the vehicle, and continually present this or these safety margins or values of purity on a graphic display unit without interfering the ongoing activity. The meaning of safety margins and values of purity shall be more clearly explained later.

Another object of the present invention is to disclose a method and a system to check in which, instead of focusing on the driver, a focusing on the dynamic behaviour of the vehicle in the existing road environment takes place and where obtained measured data will form the basis for the calculation of the actual safety margin of the vehicle for the actual driver in the actual manoeuvre situation.

Yet another object of the invention is to disclose a method to check and a device focusing on the behaviour of the vehicle in a predetermined road environment and/or in a predetermined driving (near accident) situation with a predetermined driver's behaviour. The obtained information will form the basis of a calculation and a determination of the dynamic conduct profile of a vehicle, e.g. during different load and/or road conditions. The conduct or behaviour profile for a vehicle will be further explained below.

The above mentioned objects according to the present invention are obtained by giving the method, the device and the graphic display unit the characterising clauses mentioned in the claims 1, 7 and 9, respectively.

To explain the working principles of the present invention more precisely a comparison will be made with electrical circuits where the degree of connection in an electric system is determined by parameters as impedance, resistance, inductance, etc. E.g. in a sound appliance comprising microphone, amplifier and loud speakers it is obvious that the signal has to come through “pure”, i.e. without distortion. To obtain this pureness a small part of the output signal is always fed back to the input (feed back) as a control and compensation.

In electric circuits and in the technical sound field it has since a long time been defined factors as distortion, phase displacement, self oscillations, intermodulation and so on. To check these factors, and depending which factors is to be checked, different kind of stimuli are induced in the chain, and these stimuli are compared with the feedback signal which is checked at another position in the chain. Common for these control checks is that when they are performed they are the activity itself, i.e. the ordinary activity is occasionally laid down. To perform these activities “free of interference” at the same time is not the intention. Driving a vehicle is the same situation, i.e. input/commands for manoeuvres are given all the time to the vehicle and a feed back to the driver occurs too. A check of the interaction has previously not been possible to carry out during an ongoing activity, which had to be interrupted, and the driver and the vehicle had to be studied on their own.

According to the present invention, at the same time as the activity is carried on, a check impulse is passing through the system/network, where the interaction between the driver and vehicle continuously takes place with the aim to map the degree and maybe the appearance of the feed back in the system/network. In this network the brain of the driver with its motor and sensor activities, the dynamic characteristics of the tires/the vehicle and the characteristics of the road are included, and the interfaces among these factors, i.e. steering wheels/pedals and road surface/tires are included too. It is also possible to express it in such a way that the check system according to the invention “borrow” the system network and allow a known impulse, masked by the common signal noise, to follow the common manoeuvring of the vehicle. The driver reacts mostly and most safe by reflexes, i.e. without paying attention to it and a check system with accompanying calculating program will put figures onto the difference between impulse and reply/reaction. The check pulse can be generated by the natural inherent movements of the vehicle, or may be generated by the system itself. The method, the device and the instrument according to the present invention is in the first place intended to be a support to the driver and inform him or her about existing safety margins and about the total safety margin in the interaction between driver/vehicle/road. In the method, the system and the instrument according to the invention there is included a soft ware in a simple control unit sending check pulses to the steering and/or breaking system of the vehicle. The response from the driver is sensed by sensors for steering angle, for torque and for inertia forces, and received and calculated information is sent out for presentation and/or for storing. Thus what is achieved is to indicate the actual mental presence and the competence of the driver. It can also be the case that a rapid reaction is not always of an advantage in that it may be exaggerated or out of order, and thus will be followed by a behaviour of the vehicle being hard to control. Thus all tendencies leading to strong impulsive or exaggerated reactions will immediately be uncovered.

U.S. Pat. No. 6,097,286 is a prior art technique to steer a vehicle by wire, i.e. without a mechanical steering column and steering gear. Instead a control system with servo motors and signal transmission both ways and with a feed back is arranged. In connection to the feed back technique it is mentioned that a delay in the driver's response can be registered in that that an input in the form of a short turning of the steering wheel is activated from the vehicle without turning the steering wheel. Hence here a technique is disclosed which is not active during a sharp real interaction, i.e. during the real driving of the vehicle, but a steering action onto the steering wheel is faked and is meant to trig a response from the driver. This technique seems to be less secure as long as an output from the steering wheel not followed by a corresponding change in lateral inertia force induced by turning the wheels and in a changing of the travel direction will only be confusing and thus risk to strike a tired or stressed driver with panic.

Many of the components and the control technique mentioned in said US-patent may principally be in use at a control system for a vehicle using the method and the device to measure according to the present invention. In that case another technique than steer by wire technique is used force sensors need to be arranged to register the forces acting on e.g. the steering column to have a check of input/output on both sides of the steering system, i.e. also that from the side of the vehicle or of the wheel. Reference is also made to an article in Teknikens Värld, September 1991, where a steering column is presented instead of a steering wheel and where the expressions “feed back” and “noise” in the signal transmission between the driver and the vehicle is mentioned.

Thus the invention relates to an analysis of a motor/sensor interaction/communication between a driver and a vehicle where the ability and the effort of the driver to subconsciously, and by using reflexes, keeps the balance between a wanted state and the real situation. Thus the driver acts subconsciously and parallel with an ongoing activity and will answer non verbal control questions in the form of known stimuli of such a strength and type that they are hidden in the common noise and consequently can be forwarded in the usual handling of the vehicle and wherein obtained responses may form the basis for calculations, judgements and comparisons.

Known stimuli can also be applied to the steering and/or breaking system of the vehicle wherein the direction and/or speed is influenced.

Known stimuli can also be applied to the steering wheel, the instruments and/or to the drivers seat without influencing the speed and/or direction of the vehicle.

The responses from the driver will be registered with use of one or several sensors for the steering angle, for the torque acting on the steering column, for the position of the accelerator/breaking pedal and to mesure the inertia forces acting laterally on the vehicle.

The invention also includes a method to numeric calculate a degree of purity (0=complete disconnection and 1=a perfect communication) corresponding to the ability of the driver to respond to a given impulse. Thus the purpose is to integrate the difference between normalised values to given pulses and the driver's response to these pulses, and to directly or after successive mean value calculations use the value of purity, alone or together with other measured/calculated parameters as an expression for the attention of the driver, for the safety margin, for skill, for degree of accumulated skill, etc. depending upon application.

The calculation of a value of purity (0=complete disconnection and 1=a perfect communication) corresponding to the ability of the vehicle to react onto the manoeuvres of the driver is also interesting in the context, wherein the driver's manoeuvres in the vehicle are used as a known impulse/input and that the responses from the vehicle is registered in a similar way mentioned above, wherein a purity value for the reaction/response of the vehicle can be calculated and used as a basis for an adaptation of the dynamic properties of the vehicle to an average or a specific driver, to different load conditions, to the road, etc.

The device to analyse motor and sensor interaction/communication between a driver and a vehicle include a soft ware in a computer unit, to which is connected one or several sensors and actuators, which by themselves can generate impulses of such a kind, strength and duration in time that useful answers/responses are obtained, and/or use the movements of the vehicle/driver as input, and to perform calculations, judgements and comparisons on new and earlier measured responses, whereby the result can be stored, sent to another apparatus within the vehicle, and/or be presented directly on the graphic display unit showing the purity value for the driver, for the vehicle, and by an external input/signal, the purity value for the actual road environment as three separate columns. The multiplying of these three purity values results in a calculated total safety margin in form of a horizontal and in vertical direction movable line, whereby the driver will have a possibility to be guided to a successive adaptation of his or hers driving behaviour to increase the total safety margin.

Preferably the colour of the columns will be green at high values to be yellow followed by read at lower values.

Preferably a device to check the torque acting onto the steering column may include a washer of a piezoelectric type applied in a slit or in a pocket in the steering column, whereby the torque is transferred into pressure respectively into drag forces in the axial length direction of the column, which forces are transferred to the Piezoelectric washer, in such a way that a proportional polarised electric voltage against the said torque is created over said piezoelectric washer and which voltage is transferred to the above mentioned device.

The vehicle has a certain inherent behaviour. A distinct sports car compared to a comfortable family van has different purity values or reaction coefficients. Fluctuating dynamic properties caused by different load conditions and/or by defect vehicle components is also influencing said coefficient.

Thus the driver has the greatest influence to have the road traffic system work at all, and it is only the driver who can compensate for a severe traffic situation, for a poor vehicle and for a poor road environment. Lack of experience, fatigue, inattentiveness when using the mobile phone, intoxication, etc. are factors influencing the driver coefficient or the drivers purity value in a negative way, i.e. it lowers the safety margin of the driver. For some reason there is a group of drivers who very often lacks in awareness. Many efforts have been made to identify these drivers because there is a belief that these drivers will be the first to suffer in a complex traffic situation. The problem is that this group is not static. The object of the invention is to create a tool which is really useful to the driver and which in a proper and convincing way will warn when the safety margins drops, and not only the safety margin regarding the driver.

By multiplying the coefficients of the system parts a total safety coefficient is obtained which directly corresponds to the instant safety margin for driver/vehicle/road. An example on calculation of the safety margin in a given situation is:

E.g. the authorities proclaim a lowest total safety coefficient Cₜₒₜ>0.6.

The driver has the value C₁=0.8—A fully wealthy but somewhat fatigued driver.

The vehicle has the value C₂=0.9—A good vehicle with a little worn tires.

The traffic environment has the value C₃=0.95—Sunny weather and low traffic.

Cₜₒₜ=C₁×C₂×C₃=0.68

This means that Cₜₒₜ>0.6 and this means that the safety margin is OK.

By the present invention an equipment is suggested which can be used to check the coefficient both for the driver and for the vehicle in real time.

Assistant equipment as ISA and technique for deciding e.g. road conditions, rain or snow, the temperature, and the visibility can be used in a measurement or in an appreciation of the traffic environment coefficient.

One of the main objects of the invention is to map and maybe optimise the characteristics of a vehicle in connection to on one hand a norm or standard driver or to an unique driver's behaviour and competence and to map and maybe suggest checks regarding given vehicle reactions as a response to already known manoeuvres. By studying information from sensors regarding differences, delay, resonance etc. it is also possible to determine the dynamic properties of a vehicle at a given (known) drivers behaviour. By combining the signals from the sensors with the signals from one or several sensors for inertia forces according to the invention, further characteristics of the vehicle can be decided, but also the dynamic safety in combination with a certain driver's behaviour and a certain vehicle characteristics can be uncovered.

Differing from “bench tests” and laboratory tests where the dynamic properties of a vehicle is studied using absolute quantitative values, the present invention uses the real competence and behaviour pattern of the driver as a signal processing unit which means that it is now possible to study and map the “real” performance of a vehicle in connection to the driver.

To adjust a certain property of the vehicle it is suitable to use norm drivers and to repeat measurements and gradually change e.g. the properties of the shock absorbers or the choice of tires. The characteristics obtained in graphic form will be different from one measurement to another and it is from that possible to choose the required curve shape representing the shock absorber's (the tire combinations) behaviour. In a more advanced system the characteristics of the shock absorbers is guided towards a predetermined behaviour with a certain curve shape to fit a certain driver or combination driver/vehicle. When a maximal correspondence obtained between actual curve shape and a set curve shape has been achieved the characteristics of the shock absorbers is locked, maybe in combination with a specific tire combination. This procedure can be used to automatically adjust the shock absorbers to different load conditions and/or to different drivers behaviour, tire combinations and road conditions.

The invention will be described below in connection to an embodiment shown in the accompanying drawings, where

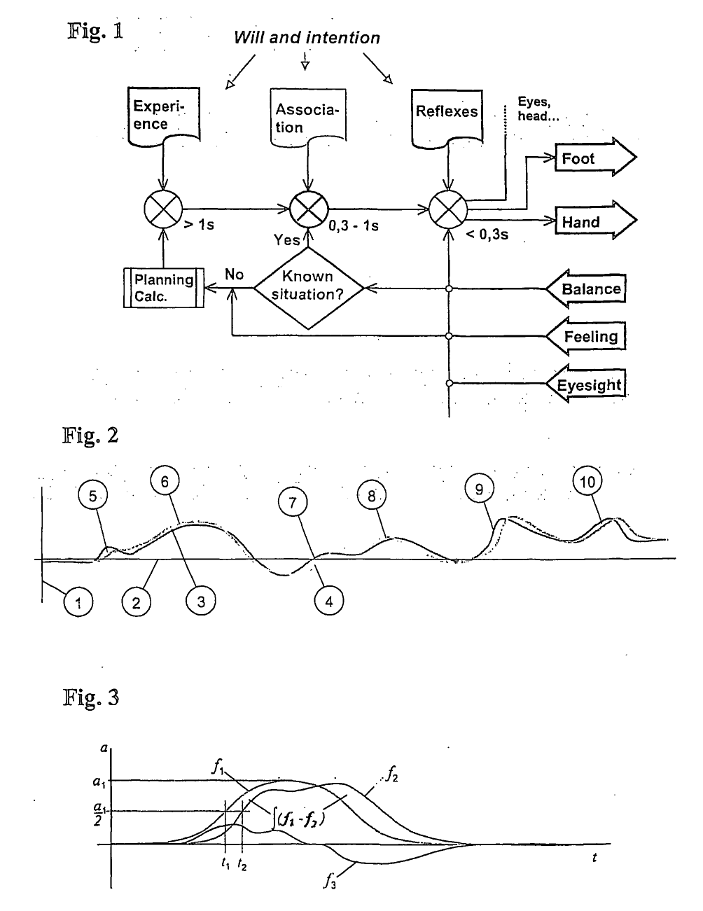

FIG. 1 is a diagrammatic view of the mental process of decision when performing a motor/sensor activity,

FIG. 2 is diagrammatically and with a diagram a vehicle's behaviour in parallel with performed readings of the steering wheel,

FIG. 3 shows a part of an instant position from the curve according to FIG. 2,

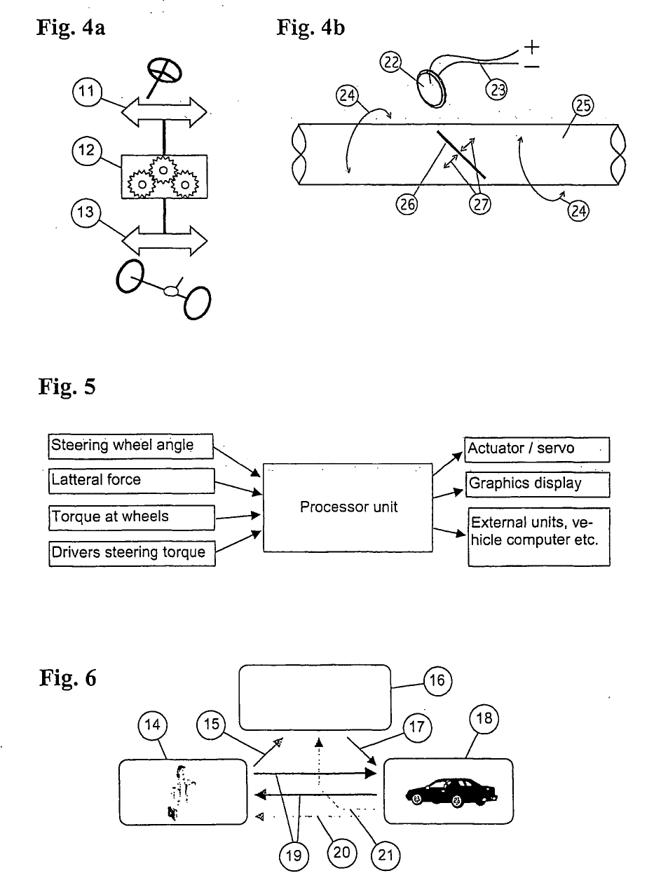

FIG. 4a is diagrammatically a steering system with forces acting on both sides of a steer gear mechanism,

FIG. 4b is diagrammatically a torque registering device of Piezo-electric type to be placed into a steering column.

FIG. 5 is a block diagram of the check sensors and input signals effecting a CPU forming part of the system, and output signals from this with the purpose to view the existing safety margins,

FIG. 6 is a diagrammatic view of the interaction between the driver and the vehicle and a controlling/supervising parasite system in accordance to the invention,

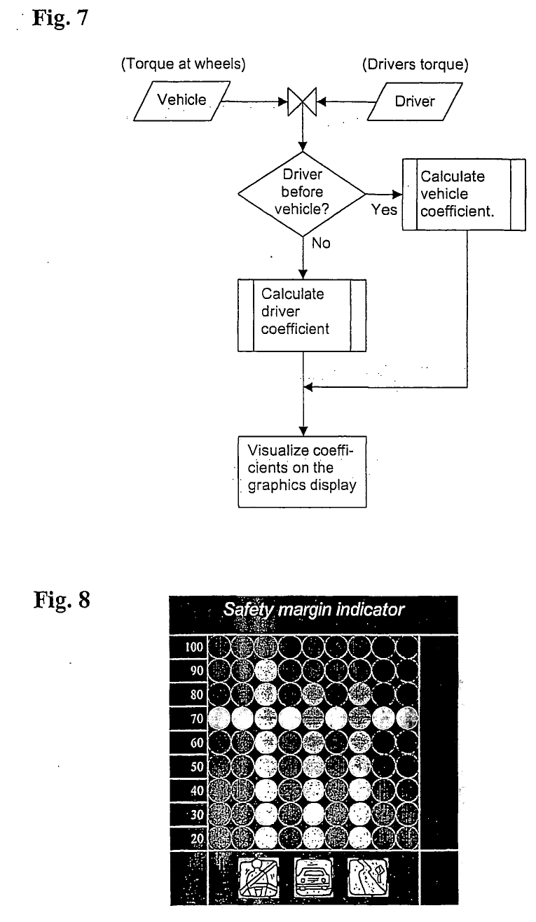

FIG. 7 show in block diagram form how the moments of the steering wheel from the driver, and from the vehicle is handled respectively, and where

FIG. 8 shows an example of how an instrument can look like and which, on one hand, shows the specific safety coefficients, the purity values or the coefficients of the driver, the vehicle and of the road, respectively.

In FIG. 1 is described in a very schematic way how information from the senses will trig the different mechanisms ruling our behaviour. Signals from the senses of balance, of feeling, of sight, etc. will be transferred to the three connection points. Dependent upon the mix of the signals and what is stored in the registers different kind of movements will be carried out.

The purpose of the flow scheme in FIG. 1 is on one hand to create an understanding for the processes in the brain enabling to rise all kind of driver education to a higher and more conscious level at the responsible persons in authority. The method and the device according to the present invention can be used as a tool to actively map and develop said three “archives”. From motor, separate reflexes to the judgement of how a driver can manage a safe behaviour in complex traffic situations. Somewhere between an association archive and an experience archive is the limit for the human consciousness. It is not sure that she is conscious about all things she do automatically even though the signals will be forwarded all the way to the experience archive. The information not needed is often not saved. The time references at the connection points is very general and is only used for a comparing purpose.

It is possible to see the difference between two kinds of documented movement or reflex patterns in connection to an activity; one showing a decrease of an earlier learnt working pattern, and the other showing a not complete pattern being under construction. I the latter case it is possible to follow a positive development of the reflex pattern in that the myelinisation of the nerve fibre patterns being used in the activity is strengthened. In the case the activity is a training of a basic behaviour, e.g. for the manoeuvring of a vehicle, it is important that the activity itself is trained in a neuro-pedagogic correct way, i.e. without any mentally limited involvement's, such as a too strong focusing on the risks and the consequences. A frightened or scared human being has drastically ruined her way to an effective learning.

Thus FIG. 1 is a picture of the mental decision process when performing a motor/sensor activity in which the reflex archive holds the information, or will trig the trained behaviour patterns being fired in a certain situation and is the most rapid and efficient memory part of the brain.

How a driver react in a given situation is not just a result of his or hers will, but also of the information being stored in the brain.

The association archive contains rule type information how to behave when a known situation happens, to put on the blinkers when turning a vehicle, or lower the speed when seeing playing children along the road, are examples of situations connected to the association archive. If the situation is more complex the driver have to calculate and plan how to react. Changing lane and overtaking are such complex manoeuvres that make use of a great deal of our consciousness

in the judgements needed. This can in fact be carried out very rapidly.

In FIG. 2 the reference 1 is a Y-axis, i.e. a normalised amplitude. 2 is the X-axis (time t). 3 is a curve having values deriving from the movement of the vehicle on the road, and 4 is a curve with values deriving from the driver's manoeuvring of the steering wheel. Reference 5 indicates a situation where the driver, with a certain delay compensate for the movements of the vehicle, and reference 6 is a situation where the driver steers the vehicle and where the vehicle is responding with a certain delay. Reference 7 is a situation where the vehicle/environment will initiate a change of direction being compensated for by the driver, and reference 8 is a situation where the driver initiate a change of direction. 9 is a situation where the driver compensates with a movement of the steering wheel.

The graphs in FIG. 3 describes a situation where the vehicle has been affected by either an unevenness in the road or of a manipulating means influencing the steering of the vehicle.

It is to be seen that the graph of the driver f₂ “lies behind” the graph f1 of the vehicle (steering) and this depends upon that it takes a certain time for the driver to react. The ability of the driver to compensate for an influence from f₁ can be read in at least two ways.

By integrating the difference between the graphs f₁ and f₂ the shady area is obtained. A fast (good) reaction from the driver will create a smaller area. The area of the surface will change over time and the shape of the change shows the pliability of the driver in the compensation act.

The amplitude of the lateral g-force f₃(t) will show the reaction time of the driver, and the shape of the curve shows the movement pattern. Irregular movements will immediately be revealed.

Furthermore an overreaction, if any, in the compensation steering response can be registered. Thus it is a risk that an overreaction in compensating steering responses will cause a hard to control behaviour of the vehicle.

The reaction time can be read as t₂−t₁ at a predetermined level, e.g. half of the top value of f₁, or by comparing the amplitude f₃ related to f₁.

f₁ represents the torque acting on the steering column from the vehicle side (influence of manipulating means).

f₂ represents the torque the driver will perform onto the steering column to compensate f₁ (a signal from the torque sensor).

f₃ represents the resulting lateral inertia forces onto the vehicle (signal from the sensors for inertia forces).

The axis a is the amplitude and the axis t is the time.

a₁ is the maximum of f₁ during a period.

The reaction of the driver can be read as t₂−t₁.

The shady area can be seen as an index of the ability of the driver to compensate for the influence of the vehicle or from a manipulating means acting on the steering column—a smaller area=a good compensation, a bigger area=a poor compensation. A tendency for an overreaction will safely be discovered too, The invention suggests that also an unaware lateral movement is initiated by using a short breaking pulse on one of the front wheels, which movement in no ways is hazardous to the safety. In this manner measurements can be carried out and the sensitivity and the mental awareness of the driver is supervised. This is done by measuring the time spent from that moment the pulse is initiated until a response is registred. Also the way to react (the force and the size of the compensating steering wheel turn) is measured and may be compared to earlier stored reaction patterns, if any, for the present driver.

When exercising on a training track the break pulse on one or more of the wheels may be stronger or even so strong that the vehicle will have a tendency to turn. A quick and correct manoeuvre carried out by the driver will prevent that. Of course these exercises shall be performed with a stepwise increasing degree of difficulty and be completely adapted to the exercising driver and his or hers ability and attained skill level. These exercises can also mean that interchanging pulses are applied to two of the wheels (on both sides) to cause and/or maybe strengthen the development of skids and return skids to allow an exercise learning to control these skids.

In FIG. 4a a steering system is diagrammatic shown with forces acting on both sides of a steer gear mechanism, where reference 11 is a sensor on a steering wheel or on a steering column to check the driver's influence on the steering system, and 12 refers to the steering system of the vehicle being of the hydraulic, electric (steer-by-wire) or the mechanical type. 13 refers to a sensor on the vehicle or wheel side of the steering system, which sensor will register the influence of the vehicle and the environment (e.g. pot holes in the road, etc.) onto the steering system.

In FIG. 4b the torque registering device including a piezo-electric element 22 of standard type, connection wires 23, a shaft 25, a slit 26 for the mounting of a sensor are shown. On the shaft 25 a torque 24 are shown, and reference 27 indicates transformed forces. The steering column with a diagonal slit transforms the torque to a linear perpendicular force. Depending on type of wanted measurement of forces, if the force is static or dynamic, different kind of sensors can be arranged in the slit. In the case there is a dynamic force or a pseudo dynamic force a standard type Piezo element will do very well. The device will transform the force or the torque to an electric voltage. Depending on the self discharge of the piezo element the lower oscillation limit is in the range of 0.1 Hz. Piezo elements can not be used to check static forces. To not drop in strength the shaft of the arrangement is preferably covered by an outer protecting pipe which will act as an mechanical reinforcement and as a protection against dirt and moisture. An outer protective pipe is not shown in the drawing.

FIG. 5 shows a block diagram of measuring sensors for the angle or deviation of the steering wheel, for lateral forces, for the torque of the steering wheel and for the steering, wherein the input signals from these sensors will influence the CPU forming part of the system. The CPU will calculate and send output signals, e.g. to a servo motor creating the hidden impulse in the system, and signals to a graphic display to show the existing security margins.

The interaction between the driver and the vehicle may be said occurring through a control system in which a continues exchange of information occurs over an interface (steering wheel/pedals) and in a two way flow lope.

Instead of trying to work on the system from “the outside”, with its enormous flow of information and with difficulties in deciding the conditions and the criteria for an accepted and for a not accepted behaviour (for the driver and for the vehicle), the present invention suggests that the whole system is encapsulated in an object orienting manner. The human brain will govern the information input and output and the result is simple to decode and to evaluate. The reaction time, step answers, resonance, instability etc., has previously only been possible to decide in clinical tests or with complex simulators. By the present invention a tool is now available and works in both real time and during travel.

The control system driver-vehicle is very complex, even though it looks quite simple in FIG. 6. The actual value and the set point values do just exist inside driver's brain. Each attempt to numerically define the system means that you have to calculate so much information that it is not practical possible.

The driver's manoeuvres on the vehicle and the feed back from the vehicle to the driver are symbolised by the two thicker arrows. The invention concerns a “parasite system” operating parallel with the ordinary system and creates a set point value of their own by giving a known pulse to the steering of the vehicle. The reply which will arrive by the driver's way of handling the steering wheel is the actual value. When both the actual and the set point values exist the difference can easily be studied, and from that final judgement can be made.

In FIG. 6 the reference 14 is the driver and 15 is a response signal from a sensor on the steering wheel/steering column. The parasite system with a micro computer and a memory to normalise, calculate and compare signals has been given the reference 16, and 17 refers to an induced “interference” or impulse applied to the steering system of the vehicle. Reference 18 is the vehicle and 19 will symbolise to normal interaction between the driver and the vehicle, or the interaction through the control system and through the steering system. The arrow 20 refers to the influence from the vehicle onto the driver—caused of, on one hand, of a self-induced interfering impulse, or, on the other hand, of an impulse coming from the movements of the vehicle and being “approved” according to the point 5, or 9 in FIG. 2. Reference 21 is a signal from a sensor on the road or wheel side 13 (FIG. 4a) and/or a sensor for inertia forces. Thus the driver's 14 manoeuvres on the vehicle 18 and the feed back to the driver is symbolised by the thick arrows 19. The present invention relates to a “parasite system” 16 operating parallel with the ordinary system and will create its own set point value 17 in that that a emitted interference pulse will be influencing the vehicle's steering system. The reaction 20, i.e. the driver's way to handle the steering wheel will be the actual value 15. Now when both the set point value and the actual exist it is easy to study the differences and from that draw conclusions. If an approved interfering impulse induced by the movements of the vehicle shall be used as an actual value this can be obtained by yet another sensor 21.

In FIG. 7 is shown a block diagram where the torque of the steering wheel and of the steering from the driver and from the vehicle, respectively is handled to be fed to a calculating unit with a CPU to decide the factors of the vehicle and of the driver.

The result of a measurement of the factors for driver and vehicle is used to decide:

a) the awareness of the driver. Must be compared with a norm factor.

b) the obtained skill of the driver. Must be compared with development of the checked values over the time.

c) the dynamic properties of the vehicle.

Finally in FIG. 8 an example of what an instrument can look like and which on one hand display the separate safety coefficients=values of purity=the coefficients for the driver, the vehicle, and for the road.

In said figure the driver has the value C₁=0.90. A wealthy and a somewhat alert driver. The vehicle has the value C₂=0.80, i.e. an approved vehicle with somewhat worn tires and shock absorbers. The traffic environment has the value C₃=0.80, i.e. normal Swedish road standard with a slotty road surface. The total security margin will be as follows

Cₜₒₜ=C₁×C₂×C₃=0.576

From the result it is clear that Cₜₒₜ<0.6 and this means that the safety is not excessive huge and that rainy weather in an essential way would make it even worse.

An experienced, healthy and fit driver has a certain degree of safety margins, let's say 100%, in driving a vehicle. He will also contribute to an increasing safety margin for other road users by driving with fantasy and with a sound judgement. When fatigued, sick, intoxicated, or performing another complex mental activity, or if the vehicle or the environment suddenly will have lower safety coefficients, the total safety margin will anyway be decreased.

The present invention is not limited to the examples mentioned above, but modifications can be done within the scope of the following patent claims.

1. A method of measuring the interaction between a driver and a vehicle in use to decide the security coefficient for vehicles and/or for drivers, characterised in that a measuring/registering and maybe calculating parasite system is connected to the steering system of the vehicle for a registering measurement of the signal quality between driver and vehicle, that implementing a known measuring impulse in the steering system in the ordinary noise during the manoeuvring of the vehicle, whereby the response from the driver on said measuring impulse will be registered by the parasite system which also compare the difference between an implemented impulse and the response from the driver, and presents said difference on a graphic display unit, as a characteristic sound, or store it in a memory device.

2. A method according to claim 1, characterised in that the impulse of the parasite system to the activity is chosen regarding size and kind in such a way that the performing of the activity is not consciously interfered.

3. A method according to claim 2, characterised in that the correcting response is compared in time and kind with reference values in a data base to decide if the activity is carried out in a safe and competent way or not.

4. A method according to any of the preceding claims, characterised in that the parameters concerning the behaviour of the vehicle is measured in connection to the trigging of known reaction patterns of the driver in given reference situations.

5. A method according to any of the preceding claims, characterised in that predetermined constellations of parameters, depending in a lateral or direction changing action onto the vehicle, may form the basis of the mapping of the behaviour of the driver and/or the vehicle.

6. A method to map and in the vehicle graphically present values corresponding to the instant safety margins for the driver, the vehicle and maybe for the road environment, charaterised in that starting from an impulse being put on the steering mechanism of the vehicle and which impulse normally demands a reflex type compensation action from the driver, the torque and/or the angle deflection the driver executes on the steering wheel in connection to the compensation is measured, that existing inertia forces is registered, whereby the measured values regarding the driver and the vehicle are collected and shown graphically, possibly together with the values representing the purity values for the traffic environment.

7. A device to check the interaction between a driver and a vehicle in use to decide the security coefficient for the vehicle/driver, characteised in that a measuring/registering and maybe calculating parasite system is connected to the steering system of the vehicle for a registering measurement of the interaction between the driver and the vehicle, and registering the response from the driver of a known measure impulse which during the use of the vehicle is implemented in the steering system and is hidden below the ordinary noise level.

8. A device according to claim 7, characterised in that the device include means to register forces acting on the steering of the vehicle, at least one sensor arranged to measure the steering deviation of the steering wheel, at least one sensor in the vehicle arranged to register actual inertia forces, and calculating means and soft ware to be used in calculating the differences between a set point or a chosen impulse and the drivers response pulse, and to transform these differences to graphically displayable signals.

9. A graphic display unit for measured values regarding the reactions of a driver and a vehicle and to display measured values obtained according to said method according to any of the claims 7 or 8, characterised in that said measured values, corresponding to the safety margins, are presented in the shape of vertical columns, and that the result of the multiplication of these values, i.e. the total security margin in an actual traffic situation for an actual driver in an actual vehicle and in an actual traffic environment is represented by a horizontal and vertically movable line.

10. An unit according to claim 9, characterised in that it is in form of a display unit with a LED matrix or with a LCD unit.
